(19) United States
(12) Patent Application Publication
(10) Pub. No.: US 2005/0138550 A1
(43) Pub. Date: Jun. 23, 2005

(54) Method and system for optimised placement of web content on device screens

(75) Inventors: Gabriel Dermler, Sindelfingen (DE); Himanshu Thube, Maharashtra (IN); Michael Wasmund, Tuebingen (DE)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, ARMONK, NY (US)

(21) Appl. No.: 11/021,205

(22) Filed: Dec. 22, 2004

(30) Foreign Application Priority Data
Dec. 22, 2003 (DE) 03104928.1

(51) Int. Cl. G06F 17/00

(52) U.S. Cl. 715/517; 715/513

(57) ABSTRACT

Web content provided in any mark-up language includes multiple web content pieces, each of which can be unformatted or formatted according to a formatting directive. The present invention teaches to apply to each formatted web content piece that consists of a specific formatting directive and formatting content one or more device-dependent size calculation factors. These factors assist in the prediction of how much space the formatted web content will consume on a particular device's screen. According to another embodiment, the consumed space prediction for web content can be employed to distribute the web content to the device.

### BACKGROUND OF THE INVENTION

1. Field of the Invention

The present invention relates to placement of web content on device screens in such a way that the available screen space is used in an optimised way. More particularly, the invention relates to a method and system for determining size calculation factors to be used for prediction of consumed space of web content.

2. Description of the Related Art

The requirement for optimal placement of web content on device screens arises in cases where a screen is too small to accommodate an entire web page. In such a case, state-of-the-art mechanisms split the web content according to some criteria into smaller pieces which are made accessible on a set of pages instead of on a single page. Splitting of the web content is performed by a pre-processing agent or proxy on behalf of the client device. Client devices are not able to communicate the amount of content they can consume for a screen on a single page. Therefore, the pre-processor has to apply some criteria to decide how much content to place on one page.

State-of-the art mechanisms establish a client-device-specific value of appropriate content size per page and compare that value against the web content which is requested to be displayed. Once the client-device-specific threshold value is reached, the remainder of the content is placed on the next page (or pages).

Current methods fail to optimise the web content for individual devices due to coarse criteria which govern the pre-processing. Criteria used to decide when to begin a new page are simple, such as the size of the web content in bytes, which is compared with the device's capability to accommodate content.

An object of the present invention is to avoid the pitfalls and disadvantages of the prior art techniques of placing web content on screens of devices with small displays.

### SUMMARY OF THE INVENTION

The invention is based on the fact that web content being provided in any mark-up language includes multiple web content pieces, each of them can be unformatted or formatted according to a formatting directive. The present invention teaches to apply to each formatted web content piece that consists of a specific formatting directive and formatting content one or more device-dependent size calculation factors which assist in the prediction of how much space the formatted web content will consume on a particular device's screen. In another embodiment of the present invention teaches how consumed space prediction for web content can be employed to distribute the web content to the device.

### BRIEF DESCRIPTION OF THE DRAWINGS

The above, as well as additional objectives, features and advantages of the present invention will be apparent in the following detailed written description.

The novel features of the invention are set forth in the appended claims. The invention itself, however, as well as a preferred mode of use, further objectives, and advantages thereof, will be best understood by reference to the following detailed description of an illustrative embodiment when read in conjunction with the accompanying drawings, wherein:

FIG. 1 shows a communication architecture in which the present invention may be preferably used;

FIG. 2 shows an example of the structure of a web content piece as used by the present invention;

FIG. 3A shows a floating diagram with the general inventive method for determining the size calculation factors;

FIG. 3B shows a floating diagram with the evaluation steps for determining space consumption of unformatted sample content;

FIG. 3C shows a floating diagram with the evaluation steps for determining space consumption of formatted sample content;

FIG. 3D shows a table of size calculation factors calculated for multiple formatting directives and devices by using the results from FIG. 3B and FIG. 3C;

FIG. 3E shows several examples of unformatted and formatted sample web content with their space consumption and their related size calculation factors;

FIG. 3F shows a floating diagram with evaluation steps for determining space consumption of formatted rows of content;

FIG. 3G shows a more detailed floating diagram with the evaluation steps for determining space consumption for unformatted/formatted rows;

FIG. 3H shows a table of size calculation factors calculated by using the results from FIG. 3F;

FIG. 3I shows examples of formatted sample content with their space consumption and their calculated size calculation factors;

FIG. 3J shows a floating diagram with the evaluation steps for determining size calculation factors for spacing between formatting directives;

FIG. 3K shows a more detailed floating diagram with the evaluation steps of space consumption of formatted sample content according to FIG. 3J;

FIG. 3L shows a table of size calculation factors for each screen device according to FIGS. 3J and 3K;

FIG. 3M shows examples of unformatted and formatted sample content according to FIG. 3J;

FIG. 3N shows a table with different formatting directives and their associated size calculation factors;

FIG. 4A shows a floating diagram with the prediction steps of space consumption of a provided web content; and

FIG. 4B shows a floating diagram with the pagination steps of web content based on the prediction of space consumption according to FIG. 4A.

### DESCRIPTION OF THE PREFERRED EMBODIMENTS

In the description that follows, terms employed herein have the following meanings. Web content refers to a delimited amount of content intended for presentation on a device screen as a unit. Web content consists of web content pieces, each of which can be formatted in a certain way. Web pages, e.g., HTML, are examples of web content. Web content pieces are a part of web content denoting enclosed content and a formatting directive describing how the content is to be presented. Web page elements, e.g., <p>, <b> elements, etc., are examples web content pieces. A Formatting directive is the part of a web content piece defining the formatting to be applied during presentation of the piece, e.g., b in <b>sample</b> defining that “bold” formatting is to be applied, I in <I>sample</I>defining that “italic” formatting is to be applied, etc. The part of a web content piece defines the content which is to be formatted according to the formatting directive (e.g., sample in <b>sample</b>, in <I>sample</I> etc.).

Available screen space or available space is a numerical value indicating the number of displayable content units. Available screen space is typically measured as the maximal number of unformatted characters which can be displayed on a screen. Other definitions are possible (e.g., number of characters in bold format which can be maximally displayed on a device screen).

Consumed screen space or consumed space is a numerical value associated with a web content piece, a set of web content pieces or a web content. It indicates the extent of consumption of available screen space by the considered content, and is measured in the same units as available screen space.

Size calculation factors are a set of rational numbers which can be used to predict the consumed space for a web content piece, a set of web content pieces or web content. They are provided per client device.

In the description that follows, a client device is a hardware device with built-in screen and (visual) browser, used by a human being to access and display web content.

A web content test sample is used to determine screen space consumption. Typically a string consisting of characters, e.g., “ABCDEFG . . . ”, but any sequence of symbols can be used as test sample.

Content overflow occurs when content requires more than the available display area for rendering. Content underflow occurs when content leaves empty space on the available display area when rendered.

A pre-processor is an intermediate entity which pre-processes content according to some criteria. Overhead is a constant factor associated with a formatting directive. Content count is the size of the content of a web content piece without taking into account formatting directives

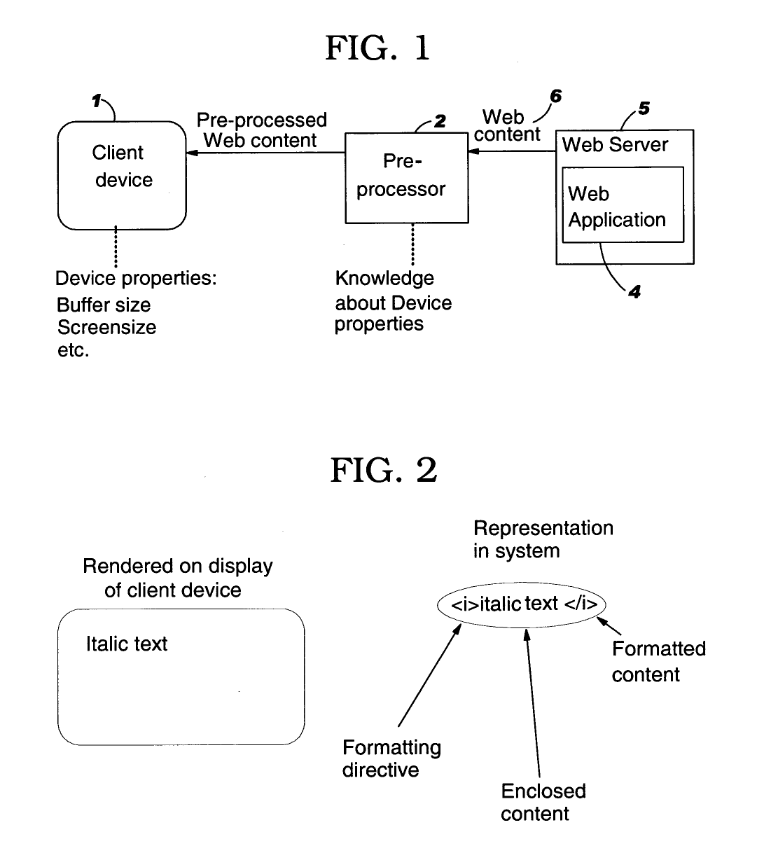

With respect to FIG. 1, a communication architecture is depicted in which the present invention may be practiced. The communication architecture is typically a client-server architecture. A web application generates web content which is to be rendered on end-user device, e.g., a mobile phone, personal digital assistant, desktop device, etc., while rendered web content enables end-user interactions with the web application on the server side. In a traditional HTTP/HTML communication structure, this corresponds to the separation of a server side web application generating HTML pages and an end user HTML browser displaying those pages.

The communication between client device and web application is preferably intercepted by a pre-processor. The pre-processor device is a device or component that has knowledge about client device properties. Its main functionality is to minimize the Web application level knowledge about end user device specifics and to determine which web content to display and how to arrange the web Content on the employed device. The pre-processor converts a received document that represents a certain web content into the mark-up representation of the target end user device. In the opposite direction, the pre-processor converts the device specific request into what is expected by the web application as input.

Since the pre-processor intercepts the communication between the client device browser and the web application, it typically acts as a network proxy or a reverse proxy. When the pre-processor acts as a network proxy, it is a single service that adapts web content coming from many different web servers or web applications. Client browsers are configured to use the pre-processor as a proxy. The proxy intercepts HTTP requests and responses as they flow between the client device and the web server.

When the pre-processor acts as a reverse proxy, it acts on behalf of one or more web applications, rather than on behalf of the client devices. In this model, client browsers are not configured to use the pre-processor as a proxy.

With respect to FIG. 2, there is depicted an example of the structure of a web content piece as used by the present invention.

Each web content received by the pre-processor consists of multiple pieces of content to be displayed on the respective user devices with their associated formatting directives. In the displayed example the formatting directive is italic that means that the web content piece should be displayed on the user device in italic. The letter “i” in the brackets determines the formatting directive. All prior art mark-up languages provide the functionality to use such formatting directive for each web content piece. Therefore, the present invention can be applied to all mark-up languages using formatting directives.

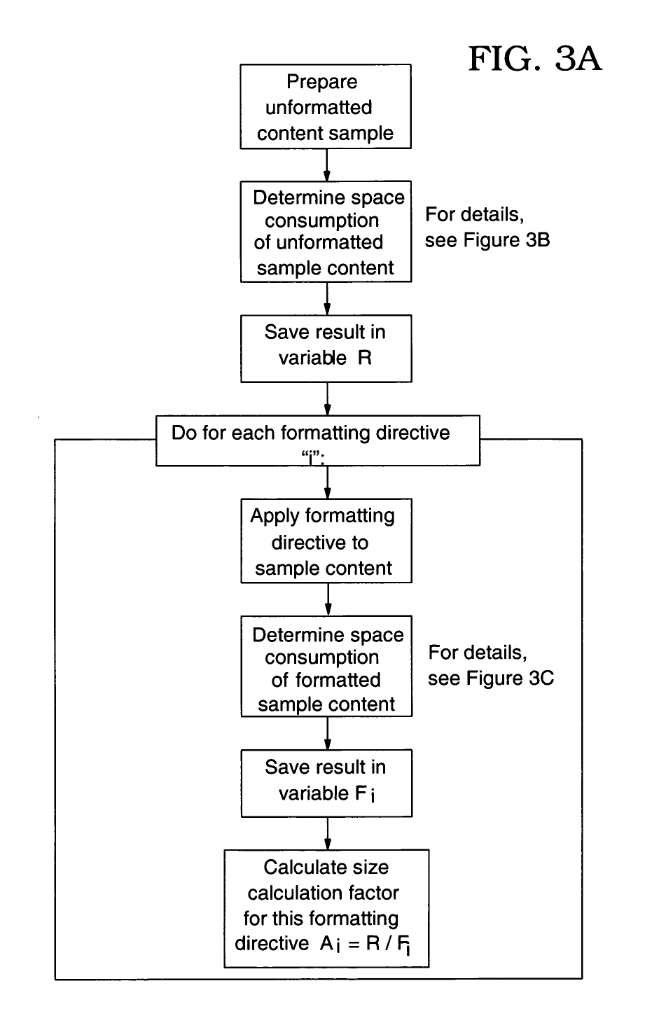

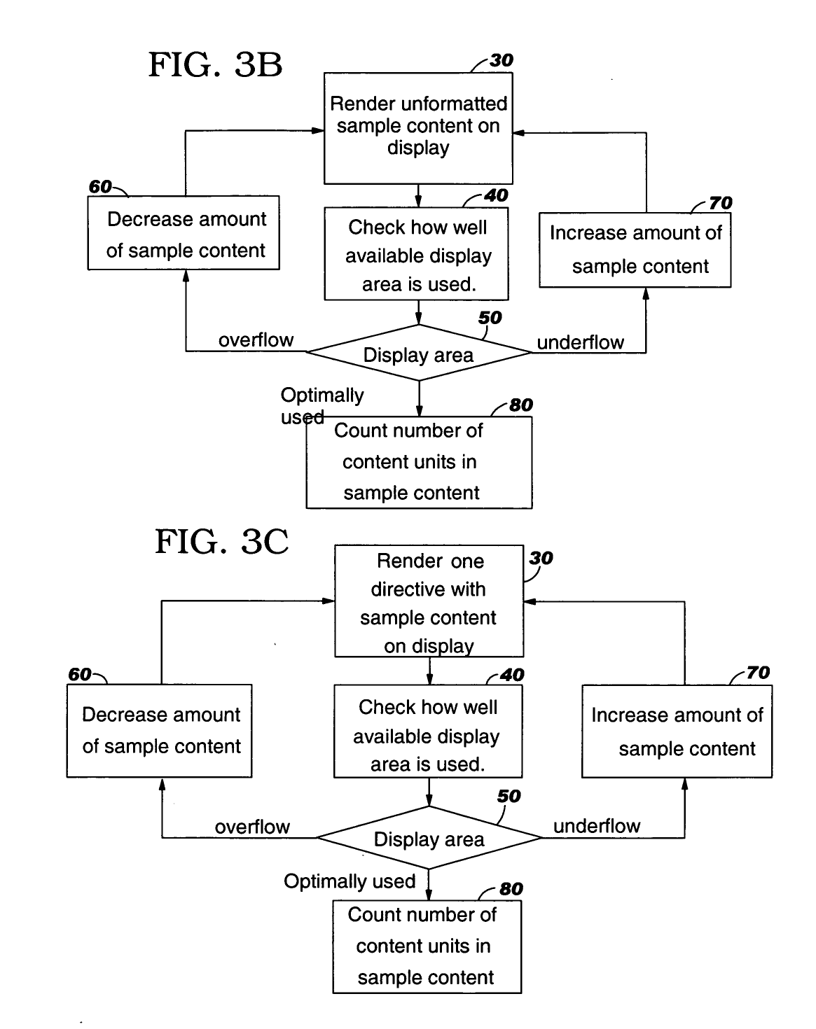

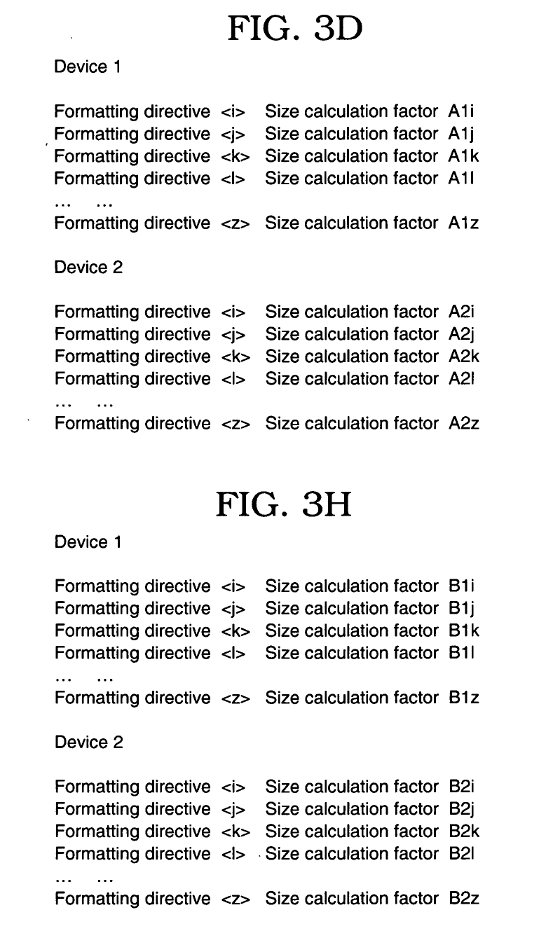

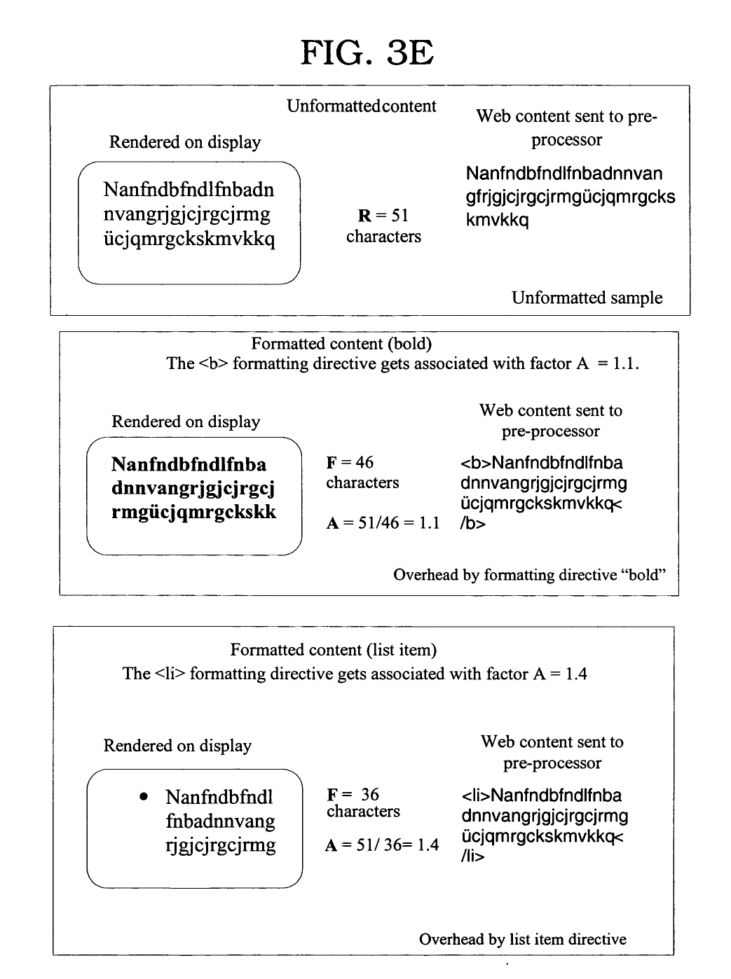

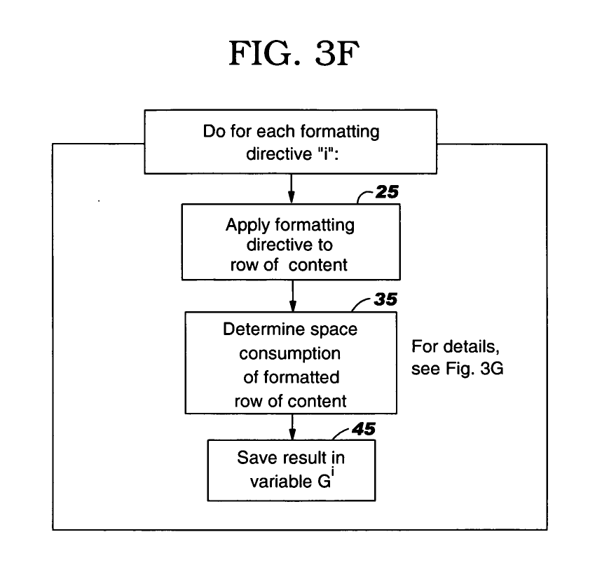

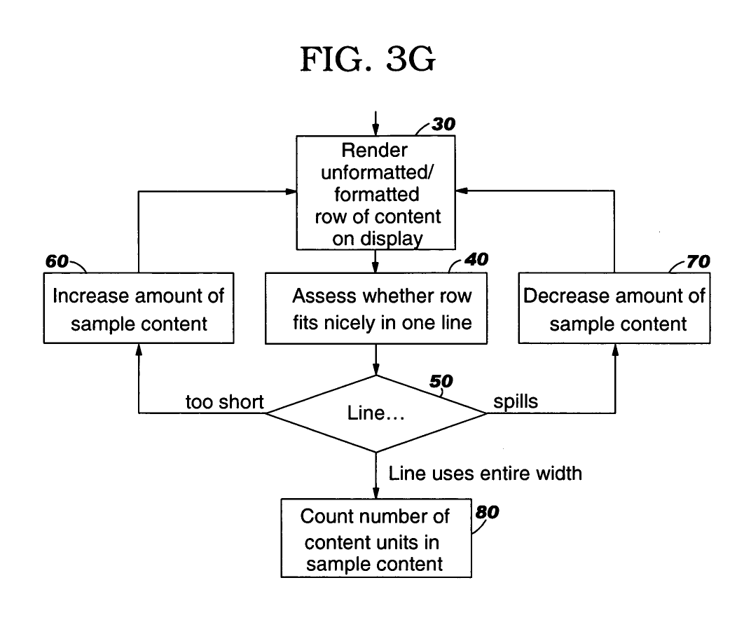

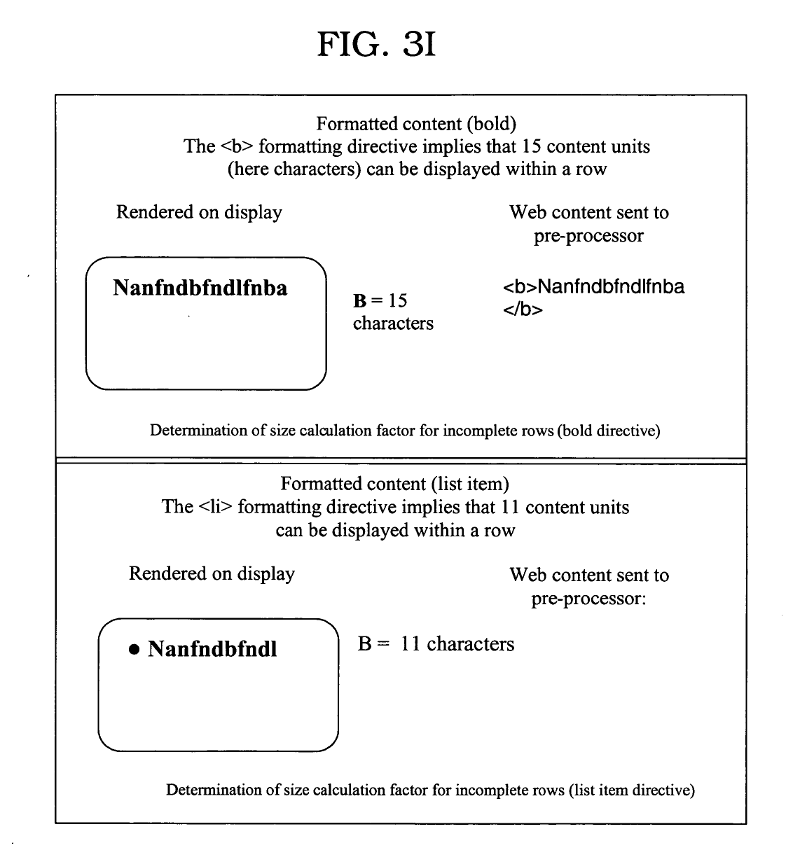

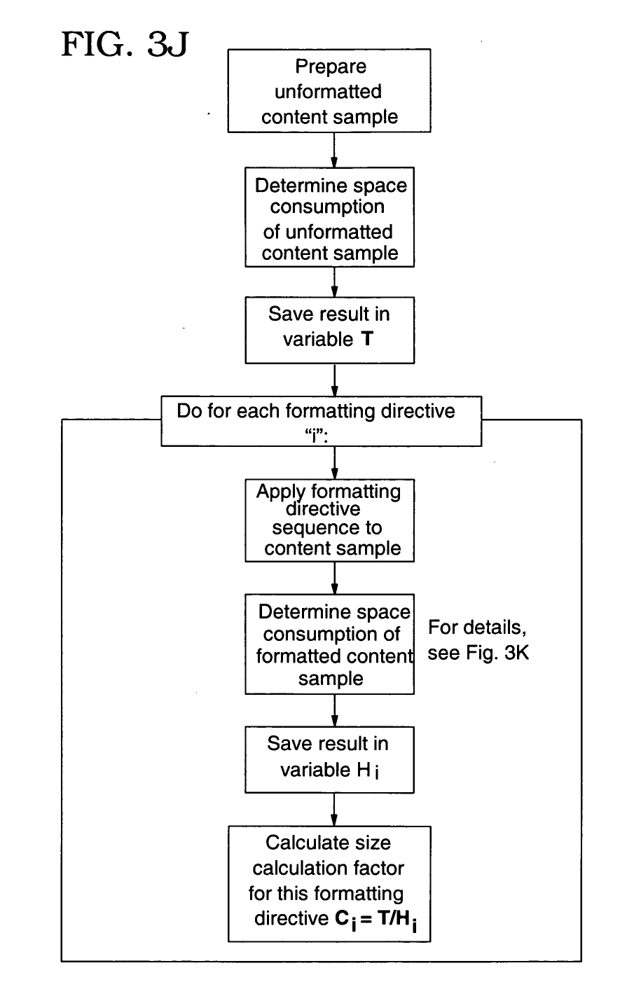

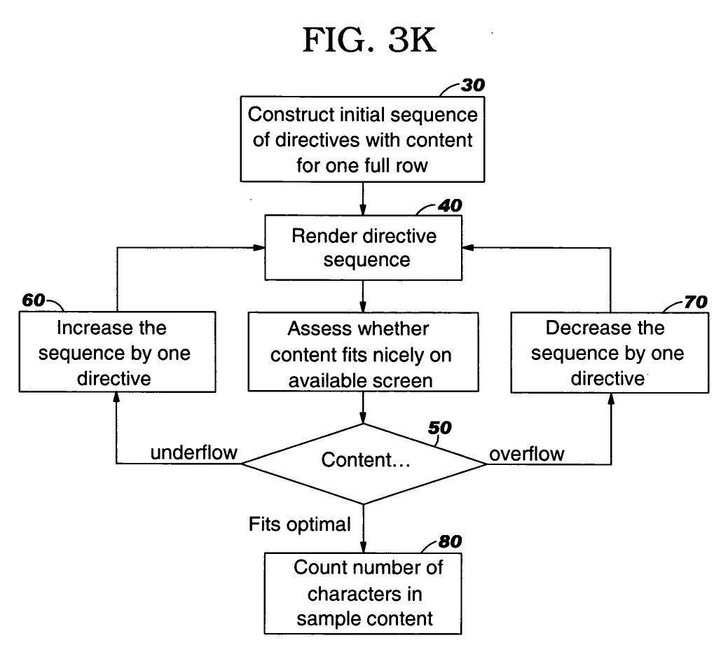

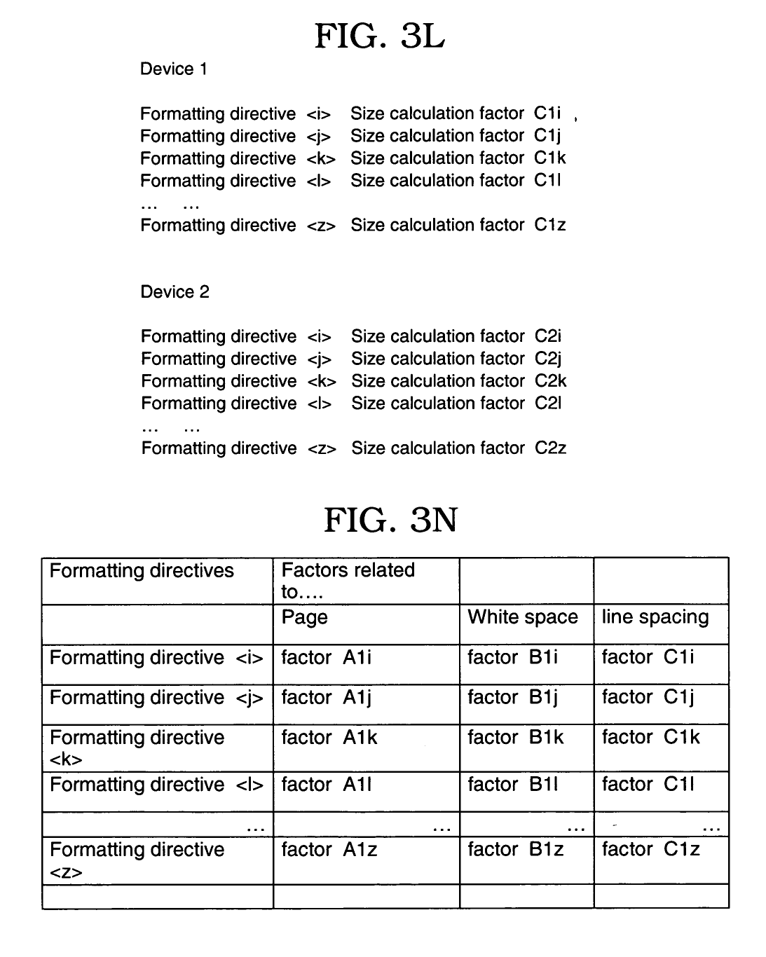

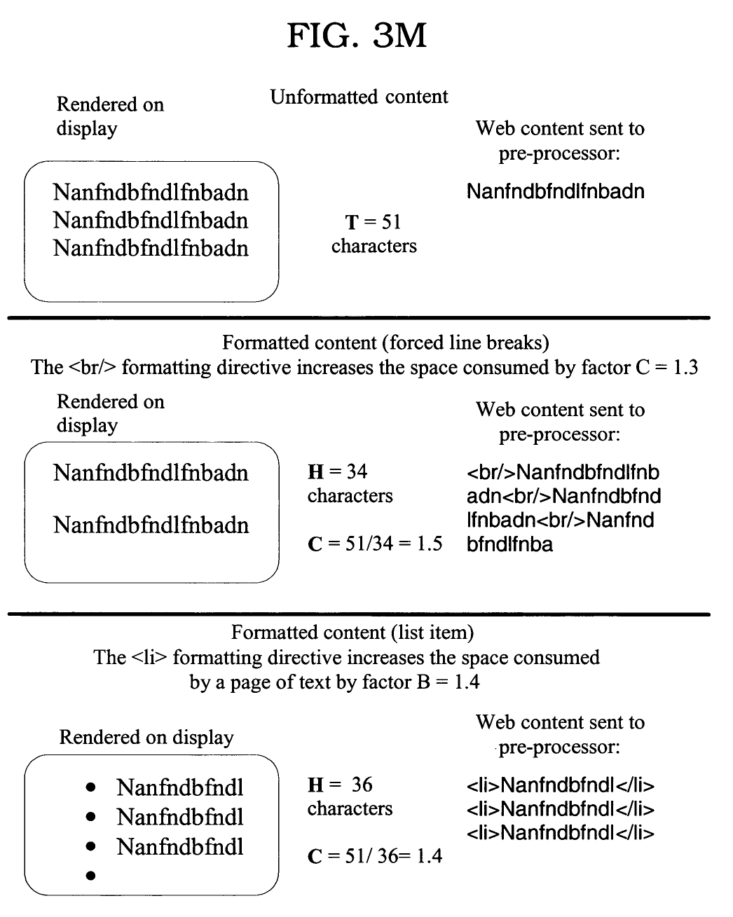

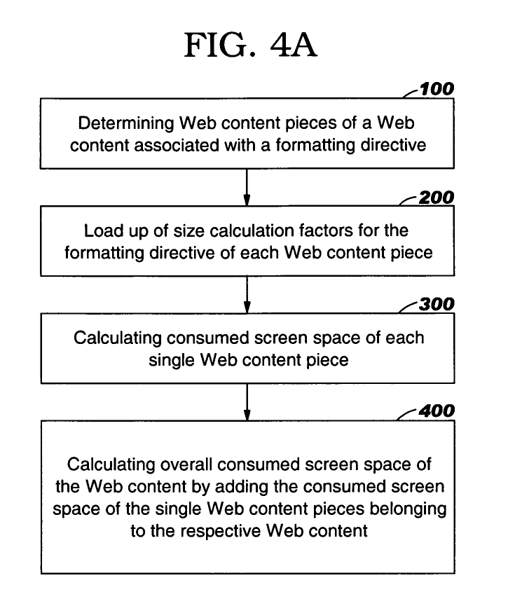

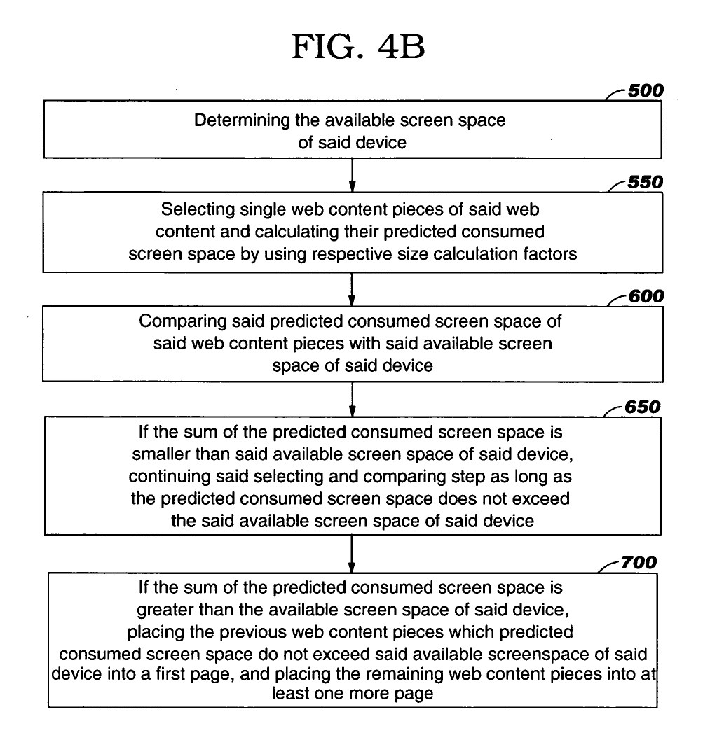

With respect to FIG. 3A, a floating diagram with the general inventive method for determining the size calculation factors is illustrated. The determination of the device-specific factors for formatting directives is illustrated in FIGS. 3A-3N. The prediction of space consumed by web content as a function of size calculation factors and as a function of web content to be processed is illustrated in FIGS. 4A-4B

Both parts of the invention are considered to be independent in the sense that (a) the size calculation factors illustrated in FIGS. 3A-3N can be used according to the prediction methods presented in FIGS. 4A-4B or according to other prediction methods not described in this patent application, and (b) the prediction methods of FIGS. 4A-4B can use factors as derived in FIGS. 3A-3N or as derived according to other methods not described in this patent application.

The present invention may preferably be implemented in a pre-processor or proxy which are inserted between a source of web content and a client device (see FIG. 1). However, the present invention may also be implemented within the source of the web content (application server) or within a client device (browser). Further, the present invention is not limited to the specific mark-up language in which the web content is expressed (for example, HTML).

A determination of device-dependent size calculation factors for each formatting directive is performed. For each “user device”, the screen space consumption is calculated by using: (1) web content with unformatted test content sample 10 (see example FIG. 3E); and (2) web content with formatted test content sample 50, 60 (see example FIG. 3F).

By comparing the screen space consumption in the unformatted case with the space consumption in the formatted case, one can derive a numerical characterization of the formatting impact 70, 80.

The approach is based on the observation that web content consists of web content pieces which are either unformatted (e.g., plain text to be displayed) or formatted (e.g., text formatted as bold, italic text, list elements, etc.)

Every formatting directive (e.g., bold, italic, list element, etc.) has an impact on the space consumption of its enclosed content (i.e., the content to be formatted). For example, content displayed in “bold” will probably consume more space than “unformatted” content. Similarly, content displayed as “list elements” will probably consume more space than “unformatted” content.

Measuring the same web content test sample (e.g., a predefined string “ABCDEF . . . ”), the space consumed in the non-formatted and in a formatted case, one can derive a format specific size “overhead” (size calculation factors 80). An example for such a result could be: “if the content is in bold, it takes 150% of the space consumed in the non-formatted case”.

By deriving the size calculation factor for every formatting directive, one can generate an prediction of the consumed space in terms of unformatted content units (e.g., characters), no matter which formatting directives are applied to the pieces of web content.

In FIG. 3B-3N, three types of size calculation factors which characterize the impact of a formatting directive are illustrated and described. These types relate to: (1) space consumption overhead due to the formatting of enclosed content (see FIG. 3A); (2) space consumption overhead due to incomplete rows of content (see FIG. 3G); and (3) space consumption overhead due to spacing between formatted web content pieces (see FIG. 3).

For each of these types, a method of computing them is described. The specific way of applying these factors to the prediction of consumed screen space for web content is described with reference to FIGS. 4A-4B.

The basic method steps for determining size calculation factor (A(i) for each formatting directive and user device is briefly summarized as follows:

In a first step, an unformatted web content test sample must be prepared (10). In the next step, the screen space consumption for that that unformatted web content test sample is determined for each user device and saved in variable R (20, 30; see FIG. 3E).

In the following step, a specific formatting directive is selected and applied to the web content test sample, and the screen space consumption for that test sample is determined for each device and saved in variable F(i)(50, 60, 70; FIG. 3F).

In a final step, the size calculation factor for each user device and formatting directive is calculated by the formula A(i)=R/F(i)(80). That size calculation factor is used for prediction of space consumption.

With respect to FIG. 3B, there is depicted a more detailed floating diagram with the evaluation steps for determining space consumption of unformatted web content test sample.

In a first step, unformatted web content test sample is displayed on a screen of a specific device 30. It is checked how well available display area is used 40. Either overflow or underflow situation is given. Content overflow means the situation when the sample content requires more than the available display for rendering.

Content underflow is the situation when the sample content leaves empty space on the available display area when rendered. When sample content overflow is given the amount of sample content is decreased (e.g., by one web content piece) and the decreased sample content is then displayed on the screen of the device 60, 30.

Again it is checked how well the available display area is used 40. This applies accordingly to the situation when content underflow is given. Then the amount of sample content is increased (e.g., by one web content piece) and the increased sample content is displayed on the screen of the device 70, 30. Again it is checked how well the available display area is used 40. Both steps are permanently repeated until the available display area is optimally used. Finally, the number of the web content pieces in the sample web content is counted 80, resulting in the variable R.

The described method for unformatted sample web content is now performed for the same web content by applying a specific formatting directive to the sample web content (e.g., italic or bold). All available formatting directives are applied to the sample web content resulting in the variable Fi. Finally, with the formula Ai=R/Fi, the size calculation factors for a specific formatting directive and device are calculated. The results of that calculation steps are laid down in a table containing the devices, the formatting directives and their assigned size calculation factors (see FIG. 3D).

In a preferred embodiment of the present invention, the table is accessible by the pre-processor for determining the prediction of space consumption for specific web content to be displayed on a specific device.

With respect to FIG. 3F, there is depicted a floating diagram with evaluation steps for determining space consumption of formatted rows of content.

The determination of size calculation factors indicates influence of formatting directives on space consumption for an incomplete row of content. The embodiment of FIG. 3A does not take into account unused space which is possibly placed at the end of a line of web content. Unused space-is caused by some formatting directives that force the display to continue the content on a new line.

The embodiment of FIG. 3F allows a determination of a size calculation factor which indicates how a formatting directive influences the amount of content which can be displayed in one row. The additional set of factors obtained by the methods illustrated in FIG. 3G can be used to further optimise the calculation of the overall space required by formatted content.

The determination of space consumption for formatted rows of content (e.g., row of characters) will now be discussed. In a first step an unformatted row of web content is to be prepared. In a next step, the screen space consumption for that unformatted row of web content is determined for each user device and saved in variable S (see FIG. 3E).

Next, a specific formatting directive is selected and applied to that prepared row of web content 25, and the screen space consumption for that formatted row of content is determined 35 for each device and saved in variable G(i)(45). In a final step, the size calculation factor for each user device and formatting directive is calculated by the formula B (i)=S/G(i)(80). This size calculation factor is used for prediction of space consumption.

With respect to FIG. 3G, a more detailed floating diagram is depicted with the evaluation steps for determining space consumption for unformatted/formatted rows. In a first step, unformatted row of context is prepared and displayed on a screen of a specific device 30. How well available display width is used is checked (whether row fits nicely in one line 40).

When sample content is spilled, the amount of sample content is decreased (e.g., by one web content piece) and the decreased sample content is then displayed on the screen of the device 50, 60, 30. Again it is checked whether the row fits nicely in one line 40. This applies accordingly to the situation when the sample content is too short. Then the amount of sample content is increased and the increased sample content is displayed on the screen of the device 50, 70, 30. Again it is checked how well available width is used 40. Both steps are permanently repeated until the available display area is optimally used.

Finally, the number of the web content pieces in the sample web content is counted 80 resulting in the variable S.

The described method for unformatted sample web content is now performed for the same web content by applying a specific formatting directive to the sample web content (e.g., list items). All available formatting directives are applied to the sample web content resulting in the variable Gi. Finally, with the formula Bi=S/Gi the size calculation factors for a specific formatting directive and device are calculated. The results of that calculation steps are laid down in a table containing the devices, the formatting directives and their assigned size calculation factors (see FIG. 3H)

In a preferred embodiment of the present invention, the table is accessible by the pre-processor for determining the prediction of space consumption for specific web content to be displayed on a specific device.

With respect to FIG. 3J, a floating diagram is depicted with the evaluation steps for determining size calculation factors for spacing between formatting directives. Determination of size calculation factors indicates the influence of formatting directives on space consumption between formatting directives.

The previous embodiments do not take into account the space which is inserted by the renderer between consecutive lines of text. The embodiment illustrated in FIG. 3J determines a set of factors which indicate how a formatting directive influences the amount of content which can be displayed on a page taking into account spacing before and after formatting directives.

The additional set of factors obtained by the methods of embodiment of FIG. 3J can be used to optimise the calculation of the overall space required by a sequence of formatting directives.

Size calculation factors are determined for spacing between formatting directives. In a first step, an unformatted sample of web content is to be prepared 10.

In a next step, the screen space consumption for that that unformatted sample of web content is determined for each user device and saved in variable T (20, 30; see FIG. 3L). In a next step, a specific formatting directive sequence is selected and applied to that prepared sample of web content, and the screen space consumption for that formatted directive sequence of web content is determined for each device and saved in variable H(i)(50, 60, 70; FIG. 3I). In a final step, the size calculation factor for each user device and formatting directive is calculated by the formula C(i)=T/H(i)(80).

That size calculation factor is used for prediction of space consumption.

With respect to FIG. 3K, a more detailed floating diagram is depicted with the evaluation steps of space consumption of formatted sample content according to FIG. 3J. In a first step unformatted sample of web context is prepared and displayed on a screen of a specific device. Either overflow or underflow situation is given. Content overflow means the situation when the sample content requires more than the available display for rendering. Content underflow means the situation when the sample content leaves empty space on the available display area when rendered.

When sample content overflow is given the amount of sample content is decreased (e.g., by one web content piece) and the decreased sample content is then displayed on the screen of the device.

Again it is checked how well the available display area is used 40.

This applies accordingly to the situation when content. underflow is given. Then the amount of sample content is increased (e.g., by one web content piece) and the increased sample content is displayed on the screen of the device 70, 30. Again it is checked how well the available display area is used 40.

Both steps are permanently repeated until the available display area is optimally used.

Finally, the number of the web content pieces in the sample web content is counted 80 resulting in the variable T (not shown in FIG. 3K).

The described method for unformatted sample web content is now performed for the same web content by applying formatting directive sequence to the sample web content resulting in the variable H(i).

Finally, with the formula C(i)=T/H(i), the size calculation factors for a specific formatting directive and device are calculated. The results of that calculation steps are laid down in a table containing the devices, the formatting directives and their assigned size calculation factors (see FIG. 3L).

In a preferred embodiment of the present invention the table is accessible by the pre-processor for determining the prediction of space consumption for specific web content to be displayed on a specific device.

The example embodiments outlined above can be applied alternatively or in combination. If applied in combination, a multi-column table of size calculation factors is obtained, which can be used in the prediction of space consumption of formatted web content. An example of such a table for one particular device is depicted in FIG. 3N.

With respect to FIG. 4A, a floating diagram is depicted with the prediction steps of space consumption of provided web content. The prediction method of the invention is based on the consumed space, which is calculated for each of the pieces of the web content.

For each web content piece associated with a formatting directive i (webContentPieceᵢ,), calculation is done as follows. First, lookup of size calculation factors (Aᵢ, Bᵢ, Cᵢ) available for the formatting directive in the respective table is performed. Next, calculation of the consumed screen space reflecting the size calculation factors is carried out. Any combination of size calculation factors can be assumed.

In the situation that only the factors of embodiment of FIG. 3A is reflected, consumed space for a web content piece can be calculated as follows:

$$PredictedConsumedSpace ( {webContentPiece}_{i} ) = {A}_{i} * ContentCount ( {webContentPiece}_{i} ) \qquad ( 1 )$$

where ContentCount denotes the size of unformatted content within the webContentPiece.

In the case that the size calculation factors of embodiments of FIG. 3A and FIG. 3F are reflected, consumed space for a web content piece can be calculated as follows:

$$PredictedConsumedSpace ( {webContentPiece}_{i} ) = {A}_{i} * RoundUp ( ContentCount ( {webContentPiece}_{i} ) , {B}_{i} ) , \qquad ( 2 )$$

where the rounding function rounds up to the next integer multiple of Bᵢ.

In the case that the factors of embodiments FIG. 3A, FIG. 3F, FIG. 3J are reflected, consumed space for a web content piece can be calculated as follows:

$$PredictedConsumedSpace ( {webContentPiece}_{i} ) = {A}_{i} * RoundUp ( ContentCount ( {webContentPiece}_{i} ) , {B}_{i} ) + {C}_{i} \qquad ( 3 )$$

where the rounding function rounds up to the next integer multiple of Bᵢ.

Based on consumed space predictions for individual web content pieces, the predicted consumed space for web content can be calculated as follows:

$$\begin{matrix}PredictedConsumedSpace ( WebContent ) = {\sum }_{i = 1}^{n} Predicted ConsumedSpace ( {webContentPiece}_{i} ) \\ = {\sum }_{i = 1}^{n} {A}_{i} * RoundUp ( ContentCount ( {webContentPiece}_{i} ) , {B}_{i} ) + {C}_{i}\end{matrix} \qquad ( 4 )$$

The above formula constitutes the general form of consumed space prediction for web content, as covered by this invention.

As noted above, some of the factors may be neglected (e.g., throughout the web content or individually per web content piece). It should be noted that the prediction formula can be applied with factors derived according to the procedures of FIGS. 3A-3N, or according to other derivation schemes not described in the present invention.

With respect to FIG. 4B, there is depicted a floating diagram with the pagination steps of web content based on the prediction of space consumption according to FIG. 4A.

Pagination of web content based on consumed space prediction will now be discussed. The following discussion describes how consumed space prediction for web content can be employed to decide on how to distribute the web content onto several presentation units (pages). This need arises when the web content is too large to be presented on the screen at once.

In a first step, for a given device, the available screen space (AS) is determined by the amount of unformatted web content that can be maximally displayed on that screen (see detailed description to FIG. 3A). Then, a first web content piece from web content is selected and the predicted consumed space is calculated by using the formula according to the description to FIG. 4A. A second web content piece is then selected and its predicted consumed space is calculated as the previous one. Both consumed spaces are added and compared with the AS.

If the sum of both web content pieces is smaller than the AS, a further web content piece is selected, its consumed space is calculated, and added to the current sum of the consumed space. This procedure is continued as long as the sum of the consumed spaces of the web content pieces does not exceed the AS.

If the sum of the consumed spaces exceeds the AS, the last web content piece is displayed on a next page. If the sum of the consumed spaces does not exceed the AS, the last web content piece is displayed on the first page.

Then, the web content pieces are identified and provided on the respective page to the client browser which displays them accordingly.

The following describes the pagination method with conjunction with example value.

| Pagination method | Example values |
|---|---|
| 1. For a given device screen, the | |
| available screen space (AS) is | AS = 100 |
| determined by the amount of | |
| unformatted content which can be | |
| maximally displayed on the screen | |
| (see Examples in Part I, Embodiment | CSC = 0 |
| 1) | WCL is empty |
| 2. Initialize a consumed space | |
| counter (CSC) to 0, a web content | |
| piece list (WCL) to <empty>. | PCS = 80 |
| 3. Start with the first web content | CSC = 0 + 80 |
| piece. | WCL contains 1 |
| | piece |
| 3.1. calculate the predicted | |
| consumed space (PCS) for this | |
| piece | |
| 3.2 Set CSC = CSC + PCS and add | PCS = 40 |
| the piece to WCL | |
| | 80 + 40 > 100 |
| 4. consider the next piece of web | |
| content (which now becomes the | |
| “current” piece), if none exists go | skipped |
| to step 6 | |
| | skipped |
| 4.1 calculate PCS for the | |
| current piece | |
| 4.2 if (CSC + PCS) > AS (i.e. the | |
| piece does not fit into the | one content piece |
| available space), go to 5 | sent. |
| 4.3 set CSC = CSC + PCS and add | |
| the piece to WCL | |
| 4.4 continue with step 4 | |
| 5. identify the pieces for the | |
| current page and send them to the | |
| browser | |
| 5.1 read out the web content | |
| pages in WCL and display them as | |
| one page | |
| 5.2 reset CSC to 0, WCL to | |
| <empty> and continue with step 4 | |
| 6. terminate web content pagination | |

While the present invention has been described with respect to specific embodiments shown in the drawings, the present invention is not limited to the specific embodiments shown in the drawings.

1. A method for determining size calculation factors for optimized placement of web content on a screen of a client device, wherein said client device communicates via a pre-processor with a web application, wherein said pre-processor pre-processes said web content provided by said web application, wherein said web content is presented in a mark-up language, wherein said mark-up language permits defining of formatting directives for web content pieces, said method comprises the steps of:
preparing a web content sample without any formatting directives;
determining a screen space consumption amount of said web content sample on a specific device screen;
saving the amount;
applying to each web content piece of said web content sample at least one formatting directive having impact to the screen space consumption;
determining a new space consumption amount of said web content sample with said applied formatting directive on said specific device screen;
saving the new amount; and
calculating a size calculation factor of each formatting directive impact by comparing the screen space consumption without and with said formatting directive.

2. A method according to claim 1, wherein each formatting directive that has an impact to the screen space consumption amount is applied to each web content piece of said web content.

3. A method according to claim 2, wherein said formatting directives relate to the formatting of the enclosed web content, or incomplete rows of web content, or spacing between formatted web content pieces.

4. A method according to claim 1, wherein said determining step for screen space consumption of web content without formatting directives comprises the sub-steps of:
decreasing said web content sample if said screen space consumption is overflown;
increasing said web content sample if said screen space consumption is underflown; and
repeating said decreasing or increasing steps until the screen space consumption amount optimally used.

5. A method according to claim 1, wherein said determining step for screen space consumption of web content with a formatting directive comprises the sub-steps of:
decreasing said web content sample if said screen space is overflown; or
increasing said web content sample if said screen space is underflown; and
repeating decreasing or increasing steps until the screen space is optimized uses the available screen space.

6. A method according to claim 1, wherein a table of size calculation factors for each device and formatting directive is created.

7. A method for prediction of space consumption of web content to be displayed on a device screen, wherein said client device communicates via a pre-processor with a web application, wherein said pre-processor pre-processes said web content provided by said web application, wherein said web content is presented in a mark-up language, wherein said mark-up language allows to define formatting directives for web content pieces, said method comprising the steps of:
selecting a first web content piece from the web content;
looking up a size calculation factor for a formatting directive associated with the first web content piece;
calculating a predicted consumed screen space amount for the first web content piece using the size calculation factor;
repeating said selecting, looking up and calculating steps for all web content pieces of the web content; and
calculating an overall predicted consumed screen space amount of the web content by adding the predicted consumed screen space amount for each of the web content pieces.

8. A method for controlling a pre-processor for providing web content to a display screen of a client device in an environment in which the client device communicates via a pre-processor with a web application, the pre-processor pre-processes web content, which comprises web content pieces, provided by the web application, the web content is presented in a mark-up language, the mark-up language permits formatting directives for the web content pieces, said method comprising the steps of:
determining available screen space for a display of the client device;
selecting one of the web content pieces of the web content, calculating a predicted amount of consumed screen space using size calculation factors and adding the predicted amount of consumed screen space to a sum of any previously predicted amounts to generate a new sum;
comparing the new sum of predicted amounts of consumed screen space of said web content pieces with said available screen space of said device;
if the new sum of the predicted amounts of consumed screen space is smaller than the available screen space of said device, repeating said selecting and comparing steps for an additional web content piece; and
if the new sum of the predicted amounts of consumed screen space is greater than the available screen space of said device, placing the previously selected web content pieces into a first page to be displayed, and placing the most recently selected web content pieces into a new page to be displayed.

9. A pre-processor in a client-server environment having a client device that communicates via the pre-processor with a web application associated with a server, the pre-processor pre-processes web content provided by the web application, the web content being presented in a mark-up language, the mark-up language permitting definition of formatting directives for web content pieces, said pre-processor comprising:
means for determining an amount of screen space available on a display of the client device;
means for selecting a web content piece from the web content and calculating a predicted screen space amount that will be consumed by the web piece using a size calculation factor;
means for adding the predicted screen space amount prediction with any previously calculated predicted screen space amount to produce a prediction sum;
means for comparing the prediction sum for said web content pieces with the available screen space amount of the display;
if the prediction sum is smaller than the available screen space amount of the display, performing said selecting, adding and comparing means for new web content pieces;
if the prediction sum of is greater than the available screen space amount of said device, placing the previously selected web content pieces into a first page for display on the client device, and placing the mostly recently selected web content piece into a second page for display; and
means for providing said pages with said respective web content pieces to the client device for display.

10. A pre-processor according to claim 9, further comprising means for calculating size calculation factors for each formatting directive and device.

11. A pre-processor according to claim 10 further comprising:
means for preparing a web content sample without any formatting directives;
means for determining a screen space consumption amount of said web content sample on a specific device screen;
means for saving the amount;
means for applying to each web content piece of said web content sample at least one formatting directive having an impact to the screen space consumption amount;
means for determining a new space consumption amount for said web content sample with said applied formatting directive on said specific device screen;
means for saving the new amount; and
means for calculating a size calculation factor of each formatting directive impact by comparing the screen space consumption amounts without and with said formatting directive.

12. A pre-processor according to claim 9, wherein said pre-processor is part of a proxy.

13. A pre-processor according to claim 9, wherein said pre-processor is part of the server.

14. A pre-processor according to claim 9, wherein said pre-processor is part of the client device.
